(19) United States
(12) Patent Application Publication
(10) Pub. No.: US 2023/0416517 A1
(43) Pub. Date: Dec. 28, 2023

(54) TRANSPARENT AND ANTIBACTERIAL ORGANIC GLASS AND MANUFACTURING METHOD THEREFOR

(71) Applicant: ZHEJIANG HUASHUAITE NEW MATERIAL TECHNOLOGY CO., LTD., Jiaxin City, Zhejiang Province (CN)

(72) Inventors: JIEHAO QU, Jiaxing City, Zhejiang Province (CN); SHENGJIONG YIN, Jiaxing City, Zhejiang Province (CN); QINQIN FAN, Jiaxing City, Zhejiang Province (CN); WANGJIE XU, Jiaxing City, Zhejiang Province (CN)

(21) Appl. No.: 18/038,003

(22) PCT Filed: Mar. 31, 2022
(86) PCT No.: PCT/CN2022/084700

§ 371 Date: May 19, 2023

(30) Foreign Application Priority Data
Jun. 1, 2021 (CN) 202110618295.9

(51) Int. Cl. C08L 33/12; C08K 5/1545

(52) U.S. Cl. CPC C08L 33/12; C08L 2201/10; C08K 5/1545

(57) ABSTRACT

A present application relates to a transparent and antibacterial organic glass, which comprises a matrix and antibacterial molecules formed on the matrix. The antibacterial molecules are stably distributed in the matrix by means of copolymerization reaction between a fat-soluble segment at a distal end and a methyl methacrylate monomer for preparing a matrix and/or inter-molecular force between the fat-soluble segment at the distal end and poly(methyl methacrylate) molecules in the matrix. The present application further relates to a method for manufacturing the transparent and antibacterial organic glass. The antibacterial molecules used in the present application have fat-soluble segments at the distal ends, and thus have excellent oleophilic properties. Since the antibacterial molecules and the matrix material are highly mutually soluble and compatible, the uniform presence of the antibacterial molecules in the organic glass is ensured. Meanwhile, the antibacterial molecules are stably distributed in the matrix by means of co-phase participation in the polymerization reaction which forms the organic glass, and are tightly bonded to form a high-transparency organic glass having efficient broad-spectrum antibacterial effects.

### CROSS-REFERENCE TO RELATED APPLICATION

The present application claims the priority of a Chinese patent application No. 202110618295.9, filed Jun. 1, 2021, applicant of “ZHEJIANG HUASHUAITE NEW MATERIAL TECHNOLOGY CO., LTD”, titled of “TRANSPARENT AND ANTIBACTERIAL ORGANIC GLASS AND MANUFACTURING METHOD THEREOF”, the entire content of which is incorporated herein by reference.

### TECHNICAL FIELD

The present application relates to the technical field of organic glass, and in particular to a transparent and antibacterial organic glass and a manufacturing method thereof.

### BACKGROUND

Organic glass (polymethyl methacrylate, PMMA) has become an important member of transparent polymer materials due to its excellent mechanical property, biocompatibility and high light transmittance, and has important application value in aerospace, rail transit, energy conservation and environmental protection, biomedicine and other fields. Applications in some common products such as protective cover of high curvature aircraft, sound barrier, transparent heat insulation panel, protective mask, windows, minimally invasive intervention catheter and the like. However, some specific application scenarios such as hospitals, schools, home improvement, etc. which urgently needs antibacterial properties are not covered in the above applications, thus the application range and functional expression of polymethyl methacrylate are limited, to a certain extent.

As known, antibacterial agents are chemicals that can inhibit the growth of pathogenic microorganisms or inactivate the pathogenic microorganisms. It's a common preparation method to introduce antibacterial agents in organic glass to obtain antibacterial function. For this, various efforts and attempts were made, such as spraying antibacterial coating on the surface of organic glass, whose antibacterial effect just depends on the surface film and is easily worn or failed in use; or adding traditional chemical antibacterial agents, whose antibacterial effect is improved, but there are problems such as surface precipitation (affecting light transmission) and low biological safety (with biological toxicity) in use. With the increasing concern about chemical residues and product safety requirements, consumers are more willing to accept the application of natural antimicrobials. In addition, due to increased resistance of pathogenic bacteria to traditional antimicrobials, natural antimicrobials are considered as an effective solution that can simultaneously address increased microbial resistance and meet consumer expectations for healthier products, and there is a growing demand for development. In recent years, a large number of studies have found that natural antimicrobials can not only inhibit the growth of bacteria, fungi and other microorganisms, but also have a wide range of source, and further have antibacterial, antioxidant and other biological activities, and excellent biocompatibility. Unfortunately, natural antibacterial molecules are usually easily soluble in water but have poor liposolubility, especially insoluble in methyl methacrylate, which restricts the direct application on the preparation of antibacterial organic glass.

The above description is intended to provide general background and does not necessarily constitute prior art.

### TECHNICAL PROBLEM

As known, antibacterial agents are chemicals that can inhibit the growth of pathogenic microorganisms or inactivate the pathogenic microorganisms. It's a common preparation method to introduce antibacterial agents in organic glass to obtain antibacterial function. For this, various efforts and attempts were made, such as spraying antibacterial coating on the surface of organic glass, whose antibacterial effect just depends on the surface film and is easily worn or failed in use; or adding traditional chemical antibacterial agents, whose antibacterial effect is improved, but there are problems such as surface precipitation (affecting light transmission) and low biological safety (with biological toxicity) in use. With the increasing concern about chemical residues and product safety requirements, consumers are more willing to accept the application of natural antimicrobials. In addition, due to increased resistance of pathogenic bacteria to traditional antimicrobials, natural antimicrobials are considered as an effective solution that can simultaneously address increased microbial resistance and meet consumer expectations for healthier products, and there is a growing demand for development. In recent years, a large number of studies have found that natural antimicrobials can not only inhibit the growth of bacteria, fungi and other microorganisms, but also have a wide range of source, and further have antibacterial, antioxidant and other biological activities, and excellent biocompatibility. Unfortunately, natural antibacterial molecules are usually easily soluble in water but have poor liposolubility, especially insoluble in methyl methacrylate, which restricts the direct application on the preparation of antibacterial organic glass.

### TECHNICAL SOLUTION

In view of the above technical problems, the present application provides a transparent and antibacterial organic glass and a manufacturing method thereof, which can obtain high transparent organic glass with efficient broad-spectrum antibacterial function.

To solve the above technical problems, the present application provides a transparent and antibacterial organic glass, including a matrix and an antibacterial molecule formed in the substrate, wherein the antibacterial molecule is stably distributed in the matrix by a copolymerization reaction between a liposoluble chain segment located at a distal end thereof and a methyl methacrylate monomer used to prepare the matrix and/or by an intermolecular force between the liposoluble chain segment and polymethyl methacrylate in the matrix.

Optionally, a mass proportion of the antibacterial molecule is less than or equal to 5%, and a mass proportion of the matrix is more than or equal to 90%.

Optionally, the antibacterial molecule includes a modified antibacterial molecule obtained from modifications to a natural antibacterial molecule with antibacterial activity, and the natural antibacterial molecule with antibacterial activity includes at least one of phenols, saponins, chitosan, defensin, lactostreptosin and reuterin.

Optionally, the natural antibacterial molecule with antibacterial activity includes a natural antibacterial molecule of plant origin with antibacterial activity, and the natural antibacterial molecule of plant origin with antibacterial activity includes catechin.

The present application further provides a manufacturing method of a transparent and antibacterial organic glass, including:
a. providing a matrix material and an antibacterial molecule having a liposoluble chain segment located at a distal end;
b. preparing a homogeneous mixture containing the matrix material, the antibacterial molecule and an initiator;
c. solidifying the homogeneous mixture so that the matrix material is polymerized to form a matrix, and the antibacterial molecule is stably distributed in the matrix by a copolymerization reaction between a liposoluble chain segment located at a distal end thereof and a methyl methacrylate monomer used to prepare the matrix and/or by an intermolecular force between the liposoluble chain segment and polymethyl methacrylate in the matrix;
d. obtaining a transparent and antibacterial organic glass.

Optionally, step a includes:
preparing an organic solution of antibacterial molecule to be modified;
adding an acid binding agent to the organic solution and stirring and adjusting to a preset temperature;
adding a modified molecule;
after a reaction is completed, carrying out washing, separation and purification to obtain the antibacterial molecule having the liposoluble chain segment located at the distal end.

Optionally, the antibacterial molecule to be modified includes a natural antibacterial molecule with antibacterial activity; chemical structure of the modified molecule includes an active group and a liposoluble chain segment, and the active group includes at least one of acyl chloride, acyl bromide and anhydride.

Optionally, step a includes:
polymerizing methyl methacrylate to form a precursor mixture containing partial polymerized precursors to obtain the matrix material; or
preparing polymethyl methacrylate resin particles into a precursor mixture with methyl methacrylate as solvent to obtain the matrix material.

Optionally, in the precursor mixture containing partial polymerized precursors, a conversion rate of the methyl methacrylate is 10%-30%; or when preparing the precursor mixture with methyl methacrylate as solvent, a mass proportion of the polymethyl methacrylate resin particles is 5%-50%.

Optionally, in step b, a mass proportion of the antibacterial molecules is less than or equal to 5%, a mass proportion of the matrix material is more than or equal to 90%, and a mass proportion of the initiator is less than or equal to 0.5%, and the initiator includes at least one of BPO, AIBN and ABVN.

The present application relates to a transparent and antibacterial organic glass including a matrix and an antibacterial molecule formed in the matrix. The antibacterial molecule is stably distributed in the matrix by a copolymerization reaction between a liposoluble chain segment located at a distal end thereof and a methyl methacrylate monomer used to prepare the matrix and/or by an intermolecular force between the liposoluble chain segment and polymethyl methacrylate in the matrix. A manufacturing method of a transparent and antibacterial organic glass is also related. The distal end of the natural antibacterial molecule used in the present application is provided with the liposoluble chain segment, thus excellent lipophilic property is obtained; further, the uniform presence of the antibacterial molecule in the organic glass is ensured due to high intermiscibility and compatibility with the matrix material. At the same time, by a co-phase participation in the polymerization reaction of the organic glass, the antibacterial molecule is stably distributed in the matrix and tightly bonded with the matrix, thus the high transparent organic glass which has effective broad-spectrum antibacterial function is obtained. The transparent and antibacterial organic glass in the present application organic glass may be prepared by traditional pouring and curing process with low cost.

### TECHNICAL EFFECTS

The transparent and antibacterial organic glass of the present application includes a matrix and an antibacterial molecule formed in the matrix. The antibacterial molecule is stably distributed in the matrix by a copolymerization reaction between a liposoluble chain segment located at a distal end thereof and a methyl methacrylate monomer used to prepare the matrix and/or by an intermolecular force between the liposoluble chain segment and polymethyl methacrylate in the matrix. A manufacturing method of a transparent and antibacterial organic glass is also related. The distal end of the natural antibacterial molecule used in the present application is provided with the liposoluble chain segment, thus excellent lipophilic property is obtained; further, the uniform presence of the antibacterial molecule in the organic glass is ensured due to high intermiscibility and compatibility with the matrix material. At the same time, by a co-phase participation in the polymerization reaction of the organic glass, the antibacterial molecule is stably distributed in the matrix and tightly bonded with the matrix, thus the high transparent organic glass which has effective broad-spectrum antibacterial function is obtained. The transparent and antibacterial organic glass in the present application organic glass may be prepared by traditional pouring and curing process with low cost.

### BRIEF DESCRIPTION OF THE DRAWINGS

FIG. 1 is a schematic diagram of the reaction principle of the natural antibacterial molecule with the modified molecule according to the first embodiment.

FIG. 2 is a flow diagram of the manufacturing method of the transparent, antibacterial organic glass according to the second embodiment.

FIG. 3 shows the performance comparison data between Processes 1-3 according to the third embodiment and the control group.

### DETAILED DESCRIPTION OF ILLUSTRATED EMBODIMENTS

The implementation of the present application will be described by specific embodiments as follows. Persons skilled in the art can easily understand other advantages and effects of the present application from the contents disclosed in this disclosure.

In the following description, several embodiments of the present application are described with reference to the attached drawings. It should be understood that other embodiments may be used, and changes on the mechanical components, structure, electrical and operational may be made without deviating from the spirit and scope of the present application. The detailed description below should not be construed as restrictive, and the terms used herein are only intended to describe the specific embodiments and not to restrict the present application.

Although the terms “first” or “second” and the like are used to describe various components in some embodiments of the present disclosure, the components should not be restricted by these terms, which are only to distinguish one component from another,

Furthermore, as used in the present disclosure, the singular forms “a”, “an”, “one” and “the” are intended to include the plural forms as well, unless the context indicates otherwise. It should be further understood that the terms “include”, “comprise” indicate the presence of the features, steps, operations, elements, components, items, kinds, and/or groups, but do not exclude the existence, occurrence, or addition of one or more other features, steps, operations, elements, components, items, kinds, and/or groups. The terms “or” and “and/or” used herein are construed as inclusive, or to mean any one or any combination. Thus, “A, B or C” or “A, B and/or C” means “any of the following: A; B; C; A and B; A and C; B and C; and A, B and C”. An exception to this definition occurs only when combinations of components, functions, steps, or operations are inherently mutually exclusive in some way.

### FIRST EMBODIMENT

The transparent, antibacterial organic glass in this embodiment includes a matrix and an antibacterial molecule formed in the matrix, and the antibacterial molecule is stably distributed in the matrix by a copolymerization reaction between a liposoluble chain segment located at a distal end thereof and a methyl methacrylate monomer used to prepare the matrix and/or by an intermolecular force between the liposoluble chain segment and polymethyl methacrylate in the matrix.

The liposoluble chain segment includes two types of saturated and unsaturated. The unsaturated liposoluble chain segment can be copolymerized with the methyl methacrylate monomer used to prepare the matrix, and the saturated liposoluble chain segment can be bonded with the polymethyl methacrylate in the matrix to form intermolecular forces. The distal end of the natural antibacterial molecule used in the present application is provided with the liposoluble chain segment, thus excellent lipophilic property is obtained; further, the uniform and stable presence of the antibacterial molecule in the organic glass is ensured due to high intermiscibility and compatibility with the matrix material. At the same time, by a co-phase participation in the polymerization reaction of the organic glass, the antibacterial molecule is stably distributed in the matrix and tightly bonded with the matrix, thus the high transparent organic glass which has effective broad-spectrum antibacterial function is obtained.

In the present embodiment, the antibacterial molecules include modified antibacterial molecules which include modified antibacterial molecule obtained from modifications to natural antibacterial molecules with antibacterial activity. The natural antibacterial molecules come from a wide range of sources, and the original hydrophilic structure thereof may be changed by modifying, thereby obtaining excellent liposolubility. In addition, the natural antibacterial molecule is endowed with biological activity that never had due to the formation of the liposoluble chain segment at the distal end of the natural antibacterial molecule. That is, due to the enhanced liposolubility, the affinity between the modified antibacterial molecule and the bacterial membrane is increased, and the antibacterial activity is also improved simultaneously.

Optionally, the natural antibacterial molecules with antibacterial activity may be derived from plants, animals, and microorganisms. The natural antibacterial molecules of animal origin with antibacterial activity mainly include at least one of lactoferrin, chitosan, lysozyme, milk protein polypeptide and defensins. The natural antibacterial molecules of microbial origin with antibacterial activity include at least one of nisin and reuterin. The natural antibacterial molecules of plant origin with antibacterial activity include at least one of phenols, quinones, saponins, coumarins, terpenoids and plant alkaloids.

Optionally, the antibacterial molecules of phenols include at least one of anthocyanins, flavonols, flavanols, isoflavones, stilbenes, tea polyphenols, tannic acids and phenolic acids.

Optionally, tea polyphenols include catechins which include at least one of epicatechin (EC), epigallocatechin (EGC), epicatechin (GC), epicatechin gallate (ECG), and epigallocatechin gallate (EGCG). Catechins are the main types of tea polyphenols, which include compounds with flavanol structure accounting for about 70%-80% of the total polyphenols, therefore have better antibacterial effect.

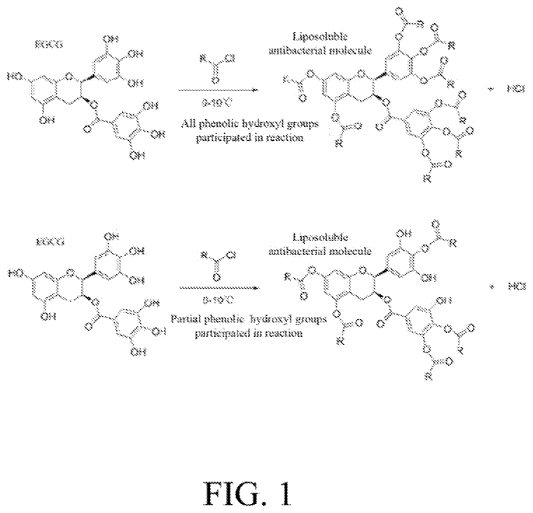

The modified antibacterial molecules are formed by the chemical reaction between the natural antibacterial molecules to be modified and the modified molecules. The specific reaction process includes: preparing an organic solution with a certain molar concentration of natural antibacterial molecules to be modified, adding an acid binding agent with an appropriate amount to the organic solution, stirring and adjusting to a preset temperature, slowly adding modified molecules, after the reaction is completed, washing with dilute hydrochloric acid, and carrying out separation and purification to obtain modified antibacterial molecules with liposolubility. FIG. 1 is a schematic diagram showing the reaction principle of the natural antibacterial molecule with the modified molecule according to the first embodiment. As shown in FIG. 1, the natural antibacterial molecule in the present embodiment is specifically EGCG, which is formed by a chemical reaction with a modified molecule (FIG. 1 is composed of a liposoluble chain segment R and an active group acyl chloride). It can be understood that, FIG. 1 is just exemplary, and R group is for representing a liposoluble chain segment. When other active groups other than acid chloride are used, such as acid bromide or acid anhydride, the structural composition thereof is similar to that shown in the figure.

The chemical structure of the modified molecule includes an active group and a liposoluble chain segment, and the active group includes at least one of acyl chloride, acyl bromide and anhydride. Specifically, when the active group is anhydride, chemical reaction of esterification modification may be carried out on the natural antibacterial molecule; when the active group is acid chloride or acid bromide, chemical reaction of acylation modification may be carried out on the natural antibacterial molecule. Optionally, the modified molecules containing reactive groups of acid chloride include at least one of stearyl chloride, undecanoyl chloride, dodecyl chloride, n-pentanoyl chloride, palmitoyl chloride, 3, 4-dimethoxy benzoyl chloride, cyclopentylmethyl acyl chloride, m-methyl benzoyl chloride, heptanoyl chloride, cyclopropylformyl chloride, m ethyl acrylyl chloride, 2-methoxyb enzoyl chloride, 4-methoxybenzoyl chloride, 3,5,5-trimethyl hexanoyl chloride, and p-ethyl benzoyl chloride, propionyl chloride, octanoyl chloride, 3 -methoxybenzoyl chloride, 4-ethoxyb enzoyl chloride, furfuryl chloride, O-acetyl salicyloyl chloride, p-methyl benzoyl chloride, 4-heptyl benzoyl chloride, 2-naphthoyl chloride, 1 -naphthoyl chloride, 3-cyclopentylpropionyl chloride, 4-n-propylbenzoyl chloride, n-butyryl chloride, and acrylyl chloride. Optionally, the modified molecules containing active groups of acyl bromide include at least one of propionyl bromide and pentanoyl bromide. Optionally, the modified molecules containing active groups of anhydride include at least one of stearic anhydride, palmitic anhydride, benzoic anhydride, phenylsuccinic anhydride, 2-(acetoxy)benzoic anhydride, isovaleric anhydride, 2-methyl succinic anhydride, butyric anhydride, 1-naphthoacetic anhydride, 2,2-dimethyl succinic anhydride, pivalic anhydride, 4-methylphthalic anhydride, methacrylic anhydride, itaconic anhydride, valeric anhydride, lauric anhydride, n-caproic anhydride, propionic anhydride, isobutyric anhydride, 2,3-dimethyl maleic anhydride, phthalic anhydride, maleic anhydride and succinic anhydride.

Optionally, the solvent forming the organic solution is at least one of ethyl acetate, ethanol, butyl acetate, methanol, acetone and isobutanol. The acid binding agent is an organic amine, such as at least one of triethylamine, diisopropylethylamine and pyridine. The acid binding agent is used to adsorb and capture the acidic residues and precipitated salt compounds produced during the substitution reaction, so as to promote the forward process of the reaction.

The molar concentration of organic solution of natural antibacterial molecules to be modified is not particularly specified, which is selectable according to the actual situation. The addition amount of corresponding acid binding agent and modified molecules are simultaneously increased with the higher concentration. The reaction time is not particularly specified, which is selectable according to the actual situation. Generally, the reaction is more adequate when the time is longer. Thin layer chromatography is utilized to determine the position of the color point of the product. The basic reaction time may be confirmed when the color point is no longer deepened. Taking EGCG in tea polyphenols as a natural antibacterial molecule for example, the molar addition amount of the modified molecules and the total molar amount of phenolic hydroxyl groups in the molecular structure of EGCG can be selected to be consistent. Optionally, in order to preserve the natural properties of tea polyphenols, remaining phenolic hydroxyl groups may be included in the present application, in which case the molar addition amount of the modified molecules should be reduced as appropriate. Optionally, in order to achieve a thorough reaction, the molar addition amount of modified molecules may be moderately increased. The antibacterial mechanism of tea polyphenols is mainly to bind peptidoglycan in the bacterial membrane by phenolic hydroxyl groups and promote the precipitation, or participate in capturing active oxygen substances in the bacterial metabolic process by a conjugated system formed by polyphenol rings to block the physiological function, thereby exerting the antibacterial effect. After the modification, although the biological active function becomes weak due to the decreased phenolic hydroxyl groups, the structure of polyphenol rings is still intact and the antibacterial function is not significantly affected. Moreover, due to the significantly enhanced liposolubility of modified antibacterial molecules and the significantly improved affinity with bacterial membrane, the overall antibacterial activity of the modified antibacterial molecules is still greatly optimized. Further, due to the non-toxic effect of the modified antibacterial molecules on normal cells and the introduction of liposoluble chain segments to enhance the antibacterial effect, desired antibacterial ability can be still obtained even for the natural antibacterial molecules, such as the phenolic hydroxyl groups in EGCG after esterification modification or acylation modification. It is worth mentioning that EGCG additionally has antioxidant effect, which efficiently to improve the anti-aging performance of the organic glass. The antioxidant activity of the modified EGCG is related to the length of the carbon chain in the liposoluble chain segment. A higher antioxidant activity is presented when 8-15 carbon atoms are included in the liposoluble chain segment, and the peroxide value inhibition rate is higher than that of unmodified EGCG.

When the active group of the modified molecule is acyl chloride or acyl bromide, the preferred range of the preset temperature is 0-25° C. When the active group of the modified molecule is anhydride, the preferred range of the preset temperature is 25-100° C.

Optionally, the mass proportion of the antibacterial molecules is the mass proportion of the matrix material is 90%. The transparent and antibacterial organic glass of the present application has efficient broad-spectrum antibacterial function on the basis of the visible light transmittance 90.69%, and antibacterial effect against Staphylococcus aureus and Escherichia coli with a reduction rate of 97.6% and 91.0% respectively can be achieved.

The transparent and antibacterial organic glass of the present application includes a matrix and an antibacterial molecule formed in the matrix. The antibacterial molecule is stably distributed in the matrix by a copolymerization reaction between a liposoluble chain segment located at a distal end thereof and a methyl methacrylate monomer used to prepare the matrix and/or by an intermolecular force between the liposoluble chain segment and polymethyl methacrylate in the matrix. A manufacturing method of a transparent and antibacterial organic glass is also related. The distal end of the natural antibacterial molecule used in the present application is provided with the liposoluble chain segment, thus excellent lipophilic property is obtained; further, the uniform and stable presence of the antibacterial molecule in the organic glass is ensured due to high intermiscibility and compatibility with the matrix material. At the same time, by a co-phase participation in the polymerization reaction of the organic glass, the antibacterial molecule is stably distributed in the matrix and tightly bonded with the matrix, thus the high transparent organic glass which has effective broad-spectrum antibacterial function is obtained. In addition, when the modified antibacterial molecules are used, the biological activity is retained, and meanwhile the liposolubility is improved since the lipid soluble groups are introduced to the modified antibacterial molecules, as a result, the solubility of the modified antibacterial molecules in the oily system is significantly improved, and the probability of contacting or capturing peroxy free radicals is significantly increased, thereby enhancing the antioxidant effect. The antioxidant effect of the modified antibacterial molecules in PMMA system is better than that of some common synthetic antioxidants such as BHA and BHT. Based on molecular modifications, specific parts of the structure of natural antibacterial molecules in the present application are acylated or esterified, making the molecular properties change from water soluble to lipid soluble, which solves the problem that natural antibacterial molecules are insoluble in the organic glass system. While retaining part of the antibacterial active groups (such as phenolic hydroxyl) of natural antibacterial molecules, on the basis of the high compatibility, the effective antibacterial concentration per unit volume is increased, and the antibacterial effect is significantly improved.

### SECOND EMBODIMENT

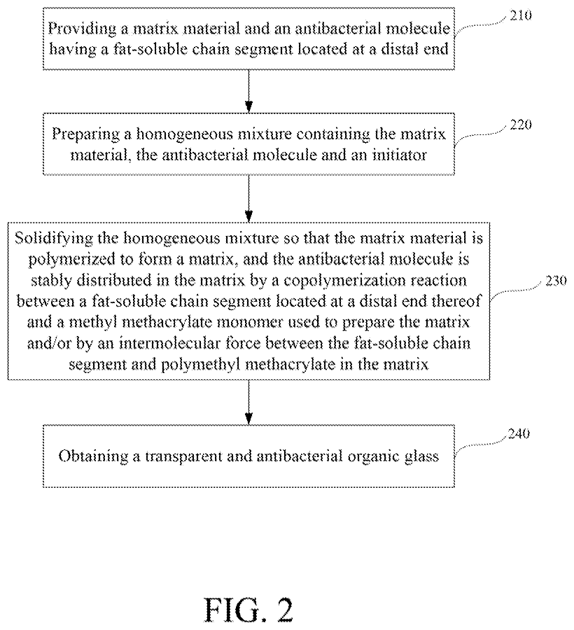

FIG. 2 is flow diagram of the manufacturing method of the transparent, antibacterial organic glass according to the second embodiment. As shown in FIG. 2, the manufacturing method of the transparent and antibacterial organic glass in this embodiment includes:

Step 210, providing a matrix material and an antibacterial molecule having a liposoluble chain segment located at a distal end;

Step 220, preparing a homogeneous mixture containing the matrix material, the antibacterial molecule and an initiator;

Step 230, solidifying the homogeneous mixture so that the matrix material is polymerized to form a matrix, and the antibacterial molecule is stably distributed in the matrix by a copolymerization reaction between a liposoluble chain segment located at a distal end thereof and a methyl methacrylate monomer used to prepare the matrix and/or by an intermolecular force between the liposoluble chain segment and polymethyl methacrylate in the matrix;

Step 240, obtaining a transparent and antibacterial organic glass. Optionally, Step 210 includes:
preparing an organic solution of antibacterial molecule to be modified; adding an acid binding agent to the organic solution and stirring and adjusting to a preset temperature;
adding a modified molecule;
after a reaction is completed, carrying out washing, separation and purification to obtain the antibacterial molecule having the liposoluble chain segment located at the distal end.

Optionally, the antibacterial molecule having liposoluble chain segments at the distal end include a modified antibacterial molecule which is obtained from modifications to a natural antibacterial molecule with antibacterial activity. The antibacterial molecules before modified include natural antibacterial molecules with antibacterial activity which may be derived from plants, animals, and microorganisms. The natural antibacterial molecules of animal origin with antibacterial activity mainly include at least one of lactoferrin, chitosan, lysozyme, milk protein polypeptide and defensins. The natural antibacterial molecules of microbial origin with antibacterial activity include at least one of nisin and reuterin. The natural antibacterial molecules of plant origin with antibacterial activity include at least one of phenols, quinones, saponins, coumarins, terpenoids and plant alkaloids.

Optionally, the antibacterial molecules of phenols include at least one of anthocyanins, flavonols, flavanols, isoflavones, stilbenes, tea polyphenols, tannic acids and phenolic acids.

Optionally, tea polyphenols include catechins which include at least one of epicatechin (EC), epigallocatechin (EGC), epicatechin (GC), epicatechin gallate (ECG), and epigallocatechin gallate (EGCG). Catechins are the main types of tea polyphenols, which include compounds with flavanol structure accounting for about 70%-80% of the total polyphenols, therefore have better antibacterial effect.

The chemical structure of the modified molecule includes an active group and a liposoluble chain segment, and the active group includes at least one of acyl chloride, acyl bromide and anhydride. Specifically, when the active group is anhydride, chemical reaction of esterification modification may be performed on the natural antibacterial molecule; when the active group is acid chloride or acid bromide, chemical reaction of acylation modification may be performed on the natural antibacterial molecule. Optionally, the modified molecules containing reactive groups of acid chloride include at least one of stearyl chloride, undecanoyl chloride, dodecyl chloride, n-pentanoyl chloride, palmitoyl chloride, 3, 4-dimethoxy benzoyl chloride, cyclopentylmethyl acyl chloride, m-methyl benzoyl chloride, heptanoyl chloride, cyclopropylformyl chloride, m ethyl acrylyl chloride, 2-methoxyb enzoyl chloride, 4-methoxybenzoyl chloride, 3,5,5-trimethyl hexanoyl chloride, and p-ethyl benzoyl chloride, propionyl chloride, octanoyl chloride, 3-methoxyb enzoyl chloride, 4-ethoxyb enzoyl chloride, furfuryl chloride, O-acetyl salicyloyl chloride, p-methyl benzoyl chloride, 4-heptyl benzoyl chloride, 2-naphthoyl chloride, 1-naphthoyl chloride, 3-cyclopentylpropionyl chloride, 4-n-propylbenzoyl chloride, n-butyryl chloride, and acrylyl chloride. Optionally, the modified molecules containing active groups of acyl bromide include at least one of propionyl bromide and pentanoyl bromide. Optionally, the modified molecules containing active groups of anhydride include at least one of stearic anhydride, palmitic anhydride, benzoic anhydride, phenylsuccinic anhydride, 2-(acetoxy)benzoic anhydride, isovaleric anhydride, 2-methyl succinic anhydride, butyric anhydride, 1-naphthoacetic anhydride, 2,2-dimethyl succinic anhydride, pivalic anhydride, 4-methylphthalic anhydride, methacrylic anhydride, itaconic anhydride, valeric anhydride, lauric anhydride, n-caproic anhydride, propionic anhydride, isobutyric anhydride, 2,3-dimethyl maleic anhydride, phthalic anhydride, maleic anhydride and succinic anhydride.

Optionally, the solvent forming the organic solution is at least one of ethyl acetate, ethanol, butyl acetate, methanol, acetone and isobutanol. The acid binding agent is an organic amine, such as at least one of triethylamine, diisopropylethylamine and pyridine. The acid binding agent is used to adsorb and capture the acidic residues and precipitated salt compounds produced during the substitution reaction, so as to promote the forward process of the reaction.

The molar concentration of organic solution of natural antibacterial molecules to be modified is not particularly specified, which is selectable according to the actual situation. The addition amount of corresponding acid binding agent and modified molecules are simultaneously increased with the higher concentration. The reaction time is not particularly specified, which is selectable according to the actual situation. Generally, the reaction is more adequate when the time is longer. Thin layer chromatography is utilized to determine the position of the color point of the product. The basic reaction time may be confirmed when the color point is no longer deepened. Taking EGCG in tea polyphenols as a natural antibacterial molecule for example, the molar addition amount of the modified molecules and the total molar amount of phenolic hydroxyl groups in the molecular structure of EGCG can be selected to be consistent. Optionally, in order to preserve the natural properties of tea polyphenols, remaining phenolic hydroxyl groups may be included in the present application, in which case the molar addition amount of the modified molecules should be reduced as appropriate. Optionally, in order to achieve a thorough reaction, the molar addition amount of modified molecules may be moderately increased. The antibacterial mechanism of tea polyphenols is mainly to bind peptidoglycan in the bacterial membrane by phenolic hydroxyl groups and promote the precipitation, or participate in capturing active oxygen substances in the bacterial metabolic process by a conjugated system formed by polyphenol rings to block the physiological function, thereby exerting the antibacterial effect. After the modification, although the biological active function becomes weak due to the decreased phenolic hydroxyl groups, the structure of polyphenol rings is still intact and the antibacterial function is not significantly affected. Moreover, due to the significantly enhanced liposolubility of modified antibacterial molecules and the significantly improved affinity with bacterial membrane, the overall antibacterial activity of the modified antibacterial molecules is still greatly optimized. Further, due to the non-toxic effect of the modified antibacterial molecules on normal cells and the introduction of liposoluble chain segments to enhance the antibacterial effect, desired antibacterial ability can be still obtained even for the natural antibacterial molecules, such as the phenolic hydroxyl groups in EGCG after esterification modification or acylation modification. It is worth mentioning that EGCG additionally has antioxidant effect, which efficiently to improve the anti-aging performance of the organic glass. The antioxidant activity of the modified EGCG is related to the length of the carbon chain in the liposoluble chain segment. A higher antioxidant activity is presented when 8-15 carbon atoms are included in the liposoluble chain segment, and the peroxide value inhibition rate is higher than that of unmodified EGCG.

When the active group of the modified molecule is acyl chloride or acyl bromide, the preferred range of the preset temperature is 0-25° C. When the active group of the modified molecule is anhydride, the preferred range of the preset temperature is 25-100° C.

Optionally, Step 210 further includes:
polymerizing methyl methacrylate to form a precursor mixture containing partial polymerized precursors to obtain the matrix material; or
preparing polymethyl methacrylate resin particles into a precursor mixture with methyl methacrylate as solvent to obtain the matrix material.

Optionally, the conversion rate of methyl methacrylate in the precursor mixture containing partial polymerized precursors is 10%-30%. Radical bulk polymerization reaction may occur between a methyl methacrylate monomer acts with an initiator (including one or several of BPO, AIBN, ABVN) under suitable temperature conditions, to form polymethyl methacrylate solution with methyl methacrylate as solvent with moderate conversion rate. Optionally, when preparing the precursor mixture with methyl methacrylate as solvent, a mass proportion of the polymethyl methacrylate resin particles is 5%-50%. In the precursor mixture, the content of polymethyl methacrylate is positively correlated with the viscosity. The viscosity becomes lower when the content of polymethyl methacrylate is lower. The thickness of organic glass is adjustable since the precursor mixture with different viscosity may be obtained. The thickness suitable for preparation may be smaller when the viscosity is lower; on the contrary, the thickness suitable for preparation may be larger. Optionally, in Step 220, the mass proportion of the antibacterial molecules is

the mass proportion of the matrix material is 90%, the mass proportion of the initiator is 0.5%, and the initiator includes at least one of BPO, AIBN and ABVN. First, the initiator is dissolved in the matrix material (a precursor mixture containing polymethyl methacrylate), and then the liposoluble antibacterial molecules are added to form a homogeneous system by two steps. The liposoluble antibacterial molecules are easily soluble in MMA, which may be fully dissolved by a simple stirring process during each step. The specific stirring process is not particularly limited, which may be in appropriate use depending on the actual situation. Optionally, by using a non-interventional homogenizer, setting reasonable revolution and rotation rate and mutual coordination under the condition of negative pressure, a bubble-free homogeneous system may be formed. In such a way, a defoaming step during the stirring process is eliminated. The liposoluble antibacterial molecules is fully soluble in methyl methacrylate, and meanwhile the precursor mixture containing polymethyl methacrylate has the natural moderate viscosity, which is further beneficial to the uniform and stable distribution of the antibacterial molecules in the matrix material. The initiator is first dissolved in the polymethyl methacrylate solution, which ensures the full utilization of the initiator and avoids the formation of unstable aggregates with antibacterial molecules.

In Step 230, the mold required for the curing of transparent and antibacterial organic glass is not particularly specified. When curing the homogeneous mixture, water bath at 45-85° C. for 1-5 h is carried out first, followed by air bath at 100-130° C. for 1-5 h. As shown in FIG. 1, the liposoluble chain segments R are located at the distal ends of the antibacterial molecule. By the characteristic molecular structure and action of the liposoluble chain segment R, the antibacterial molecule may undergo free radical copolymerization (such as the presence of ene bond in segment R) with methyl methacrylate monomers and is polymerized into the polymethyl methacrylate chain; or, intermolecular force may be formed between liposoluble chain segment and the polymethyl methacrylate chain, in such a way, tight bonding between the antibacterial molecule/organic glass interface at the molecular scale is formed by means of covalent bond or intermolecular force.

In the present application, liposoluble graft modification is carried out on the phenolic hydroxyl groups and amino groups (primary amine or secondary ammonia) in the natural antibacterial molecules, thus the limitations of the natural antibacterial molecules insoluble in methyl methacrylates, easy oxidation and low stability are solved at the same time; by a co-phase participation in the polymerization and formation of the organic glass, the transparent and antibacterial organic glass is finally obtained. On the basis of the visible light transmittance 90.69%, antibacterial effect against Staphylococcus aureus and Escherichia coli with a reduction rate of 97.6% and 91.0% respectively can be achieved. Further, the organic glass may be prepared by traditional pouring and curing process with low cost, so that the application of organic glass as the main transparent material can be extended to the medical field closely related to life and health, which provides a reliable solution and inspiration for the demand of transparent and antibacterial organic glass in scientific research and production activities.

Different processes realized by the manufacturing method based on the present embodiment are listed below.

### Process 1

Preparation of modified antibacterial molecules includes the following steps.

In a 500 mL three-neck flask, EGCG and ethyl acetate were added successively to form 300 mL solution with molar concentration of 1 mol/L, and 5 mL pyridine was added. The flask was placed in water bath at 0-10° C., and a thermometer and a condensate tube were installed. With stirring, 1.92 mol acrylyl chloride (80% of the molar amount of phenolic hydroxyl groups in EGCG) was slowly added. The concentration change of the product was judged by thin layer chromatography. When the color of the color point was no longer deepened, the reaction was continued for 1-2 h. Then, washing with dilute hydrochloric acid and distilled water for several times (to remove excess EGCG and impurities), after removing the water layer, adding excessive water-absorbing agent for drying and filtration, the remaining organic phase was vacuumed at room temperature overnight to obtain modified antibacterial molecules.

Next, the following steps are carried out:
C. a preparation step of polymethyl methacrylate solution with moderate conversion rate during bulk polymerization of methyl methacrylate;
D. a formation step of a compound ligand with appropriate proportion among modified antibacterial molecules, polymethyl methacrylate solution and supplementary initiator;
E. a curing step of forming transparent and antibacterial organic glass.

Specifically, the moderate conversion rate mentioned in Step C may be specifically 10-30%, and 10% is selected in this process.

In Step D, the appropriate proportion represents a proportion by mass, which may be that, modified antibacterial molecules polymethyl methacrylate solution 95%, and supplementary initiator 0.5%. The supplementary initiator includes one or several of BPO, AIBN and ABVN. In this process, 0.1% modified antibacterial molecules, 99.7% polymethyl methacrylate solution and 0.2% supplementary initiator ABVN were used.

The curing step is sequentially composed of a water bath at 45-85° C./1-5 h and an air bath at 100-130° C./1-5 h. In this process, water bath at 45-75° C./5 h and air bath at 100-130° C./2 h were used.

### Process 2

Compared with Process 1, the difference was only that stearic anhydride was selected as the modified molecule, with the amount of 2.4 mol (the same as the molar amount of phenolic hydroxyl groups in EGCG).

### Process 3

Compared with Process 1, the difference was only that valyl bromide was selected as the modified molecule, with the amount of 2.88 mol (120% of the molar amount of phenolic hydroxyl groups in EGCG).

The following is the performance analysis of the transparent and antibacterial organic glass produced by Processes 1-3.

### Sample Preparation

Control group: consistent with the existing manufacturing technology of ordinary organic glass, the specific process will not be repeated, and the sample size is 50 mm×50 mm×4 mm; Process 1-3: the sample size is 50 mm×50 mm×4 mm.

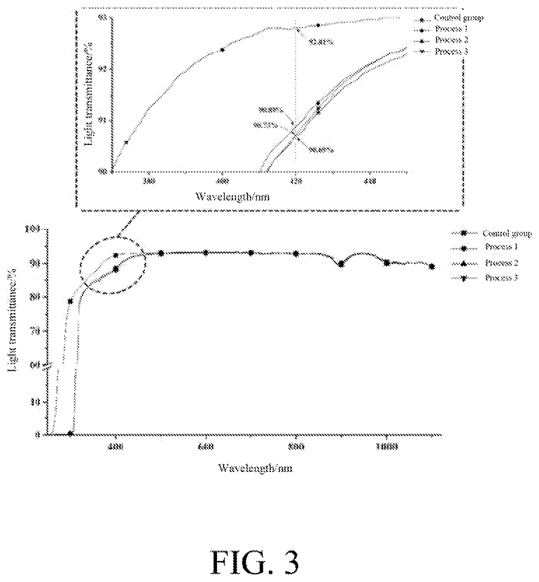

UV-Vis spectral characterization was performed on the above control group, Process 1, Process 2 and Process 3, with the wavelength range of 250-1100 nm, the transmittance of visible light region was tested according to Poly(methyl methacrylate) Cast Sheets (GB/T 7134-2008), and the light transmittance data at the wavelength of 420 nm was obtained. The specific results are shown in FIG. 3, the light transmittance at 420 nm in the control group was 92.81%, and the light transmittance of Processes 1-3 was 90.89%, 90.69% and 90.73% respectively, which was similar to that of the control group, and difference therebetween in light transmittance performance could not be discerned by the naked eye;

further, the spectral curves of the four groups were basically identical when the wavelength was larger than 500 nm, which shows that the light transmission performance of antibacterial organic glass was quite consistent with that of the control group, and the effect of antibacterial modification on the light transmission performance was slight and could be basically ignored. Antibacterial test was carried out according to Antibacterial Test Standard for Plastic Products (ISO 22196-2011). Common Staphylococcus aureus and Escherichia coli were selected for the test bacteria. Statistical results in Table 1 shows that the control group had no antibacterial effect, after 24 hours of bacterial culture, the number of Staphylococcus aureus and Escherichia coli increased by about 64 times and 18 times respectively. While in Processes 1-3, the maximum reduction rate of Staphylococcus aureus and Escherichia coli was 97.6% and 91.0%, respectively, and the reduction rate fluctuated in a narrow range of 95.3-97.6% and 90.1-91.0%, respectively, indicating high data stability. In addition, the basic physical properties were tested and characterized according to Poly(methyl methacrylate) Cast Sheets (GB/T 7134-2008), and the results showing that the basic physical properties of Processes 1-3 and the control group were statistically consistent, which will not be repeated here.

TABLE 1
Statistics of light transmittance and antibacterial results

| | Control | Pro- | Pro- | Pro- |
|---|---|---|---|---|
| Item | group | cess 1 | cess 2 | cess 3 |
| Light transmission/% | 92.81 | 90.89 | 90.69 | 90.73 |
| Reduction rate of | −6445.5% | 97.6 | 96.2 | 95.3 |
| Staphylococcus | | | | |
| aureus/% | | | | |
| Reduction rate of | −1810.1% | 91.0 | 90.1 | 90.8 |
| Escherichia | | | | |
| coli/% | | | | |

The distal end of the natural antibacterial molecule used in the present application is provided with the liposoluble chain segments, thus the original hydrophilic structure of the natural antibacterial molecule is changed, thereby obtaining an antibacterial molecule with excellent lipophilic property; further, the uniform and stable presence of the antibacterial molecule in the organic glass is ensured due to high intermiscibility and compatibility with the matrix material. At the same time, by a co-phase participation in the polymerization reaction of the organic glass, the antibacterial molecules are stably distributed in the matrix and tightly combined with the matrix, thus the high transparent organic glass which has effective broad-spectrum antibacterial function is obtained.

Additionally, the transparent and antibacterial organic glass in the present application organic glass may be prepared by traditional pouring and curing process with low cost.

The above embodiments are illustrative only for the principle and effect of the present application and are not intended to restrict the present application. Modifications or alterations may be made on the above embodiments by any person skilled in the art, within the spirit and scope of the present application. Therefore, all modifications or alterations made by persons skilled in the art without deviating from the spirit and technical principle revealed in the present application shall be included in the protection scope of the technical solution.

### INDUSTRIAL PRACTICABILITY

The transparent and antibacterial organic glass of the present application includes a matrix and an antibacterial molecule formed in the matrix. The antibacterial molecule is stably distributed in the matrix by a copolymerization reaction between a liposoluble chain segment located at a distal end thereof and a methyl methacrylate monomer used to prepare the matrix and/or by an intermolecular force between the liposoluble chain segment and polymethyl methacrylate in the matrix. A manufacturing method of a transparent and antibacterial organic glass is also related. The distal end of the natural antibacterial molecule used in the present application is provided with the liposoluble chain segment, thus excellent lipophilic property is obtained; further, the uniform and stable presence of the antibacterial molecule in the organic glass is ensured due to high intermiscibility and compatibility with the matrix material. At the same time, by a co-phase participation in the polymerization reaction of the organic glass, the antibacterial molecule is stably distributed in the matrix and tightly bonded with the matrix, thus the high transparent organic glass which has effective broad-spectrum antibacterial function is obtained. The transparent and antibacterial organic glass in the present application organic glass may be prepared by traditional pouring and curing process with low cost.

What is claimed is:

1. A transparent and antibacterial organic glass, comprising a matrix and an antibacterial molecule formed in the substrate, wherein the antibacterial molecule is stably distributed in the matrix by a copolymerization reaction between a liposoluble chain segment located at a distal end thereof and a methyl methacrylate monomer used to prepare the matrix and/or by an intermolecular force between the liposoluble chain segment and polymethyl methacrylate in the matrix.

2. The transparent and antibacterial organic glass according to claim 1, wherein a mass proportion of the antibacterial molecule is less than or equal to 5%, and a mass proportion of the matrix is more than or equal to 90%.

3. The transparent and antibacterial organic glass according to claim 1, wherein the antibacterial molecule comprises a modified antibacterial molecule obtained from modifications to a natural antibacterial molecule with antibacterial activity, and the natural antibacterial molecule with antibacterial activity comprises at least one of phenols, saponins, chitosan, defensin, lactostreptosin and reuterin.

4. The transparent and antibacterial organic glass according to claim 3, wherein the natural antibacterial molecule with antibacterial activity comprises a natural antibacterial molecule of plant origin with antibacterial activity, and the natural antibacterial molecule of plant origin with antibacterial activity comprises catechin.

5. A manufacturing method of a transparent and antibacterial organic glass, comprising:
a. providing a matrix material and an antibacterial molecule having a liposoluble chain segment located at a distal end;
b. preparing a homogeneous mixture containing the matrix material, the antibacterial molecule and an initiator;
c. solidifying the homogeneous mixture so that the matrix material is polymerized to form a matrix, and the antibacterial molecule is stably distributed in the matrix by a copolymerization reaction between a liposoluble chain segment located at a distal end thereof and a methyl methacrylate monomer used to prepare the matrix and/or by an intermolecular force between the liposoluble chain segment and polymethyl methacrylate in the matrix;
d. obtaining a transparent and antibacterial organic glass.

6. The manufacturing method of a transparent and antibacterial organic glass according to claim 5, wherein step a comprises:
preparing an organic solution of antibacterial molecule to be modified;
adding an acid binding agent to the organic solution and stirring and adjusting to a preset temperature;
adding a modified molecule;
after a reaction is completed, carrying out washing, separation and purification to obtain the antibacterial molecule having the liposoluble chain segment located at the distal end.

7. The manufacturing method of a transparent and antibacterial organic glass according to claim 6, wherein the antibacterial molecule to be modified comprises a natural antibacterial molecule with antibacterial activity; chemical structure of the modified molecule comprises an active group and a liposoluble chain segment, and the active group comprises at least one of acyl chloride, acyl bromide and anhydride.

8. The manufacturing method of a transparent and antibacterial organic glass according to claim 5, wherein step a comprises:
polymerizing methyl methacrylate to form a precursor mixture containing partial polymerized precursors to obtain the matrix material; or
preparing polymethyl methacrylate resin particles into a precursor mixture with methyl methacrylate as solvent to obtain the matrix material.

9. The manufacturing method of a transparent and antibacterial organic glass according to claim 8, wherein in the precursor mixture containing partial polymerized precursors, a conversion rate of the methyl methacrylate is 10%-30%; or when preparing the precursor mixture with methyl methacrylate as solvent, a mass proportion of the polymethyl methacrylate resin particles is 5%-50%.

10. The manufacturing method of a transparent and antibacterial organic glass according to claim 5, wherein in step b, a mass proportion of the antibacterial molecules is less than or equal to 5%, a mass proportion of the matrix material is more than or equal to 90%, and a mass proportion of the initiator is less than or equal to 0.5%, and the initiator comprises at least one of BPO, AIBN and ABVN.
